(19) United States
(12) Patent Application Publication
(10) Pub. No.: US 2013/0192863 A1
(43) Pub. Date: Aug. 1, 2013

(54) Multi-Functional Electric Power Tool with Safety Shift Device

(71) Applicants: Jining Hu, Yongkang (CN); Yuan Zheng, Yongkang (CN)

(72) Inventors: Jining Hu, Yongkang (CN); Yuan Zheng, Yongkang (CN)

(73) Assignee: ZHEJIANG TCH INDUSTRIAL CO., LTD., Yongkang, Zhejiang (CN)

(21) Appl. No.: 13/824,992

(22) PCT Filed: Sep. 19, 2011
(86) PCT No.: PCT/CN2011/079805

§ 371 Date: Mar. 19, 2013

(30) Foreign Application Priority Data
Sep. 20, 2010 (CN) 201020540627.3

(51) Int. Cl. B25F 5/00

(52) U.S. Cl. CPC B25F 5/001
USPC 173/216

(57) ABSTRACT

It is one kind of hand-held electric power tool with safety shift device, including housing assembly, motor, end cap of gear box, gear box, output shaft, final-stage rack wheel, final-stage pinion, gear pin roll, safety shift pin roll, gear knockout plate, gear synchronous spring, safety shift spring, safety push rod, stop pin, variable-speed pinion axis, variable-speed rack wheel, big bevel pinion, bevel pinion and grinding wheel shield. Among which, the gear pin roll and safety shift pin roll are installed within the gear box in parallel, the gear knockout plate is connected with final-stage rack wheel and final-stage pinion, the gear synchronous spring is installed on the gear pin roll while the safety shift spring is installed on the safety shift pin roll. This new practical hand-held electric power tool with safety shift device is characterized by low-speed gear automatic recovery function and the dangers of disoperation will be avoided, being safe and convenient.

### FIELD OF THE INVENTION

It is one kind of new practical hand-held electric power tool, and more specifically, the multi-functional electric power tool with safety shift device.

### BACKGROUND OF THE INVENTION

Currently, although the electric angle grinder, electric polisher and electric sawing machine are similar with each other in terms of appearance and power system, the rotation speed of the grinding wheel of the working head of electric angle grinder is far higher than that of the rest ones and, due to the requirements of different working heads and the cause of safety linear velocity of the polishing disk and saw blade, necessary safety protection device is in urgent demand to ensure that different working heads can operate under the proper safety rotation speed. Therefore, people would rather not integrate the functions of all the three machines above to realize the multi-purpose target of three functions in one so as to fully exert their functions.

### SUMMARY OF THE INVENTION

This is one kind of multi-functional electric power tool with safety shift device, in order to overcome the necessary safety protection device unavailable in the current technology, resulting in the failure in realizing the multi-purpose target of three functions in one.

The technical scheme of this new practical tool in technical problem solving: It is one kind of hand-held electric power tool with safety shift device, including housing assembly, motor, end cap of gear box, gear box, output shaft, final-stage rack wheel, final-stage pinion, gear pin roll, safety shift pin roll, gear knockout plate, gear synchronous spring, safety shift spring, safety push rod, stop pin, variable-speed pinion axis, variable-speed rack wheel, big bevel pinion, bevel pinion and grinding wheel shield. Among which, the motor is installed within the housing assembly, which is connected with the gear box; the end cap of the gear box is connected with the other end of the gear box. The output shaft is installed within the gear box but comes out from the end cap of the gear box. The final-stage rack wheel is installed on the final-stage pinion in form of front and back axial direction. The final-stage rack wheel and final-stage pinion are installed on the output shaft in form of spline with the following features: both ends of the gear pin roll are installed in the gear box and the end cap of gear box respectively; both ends of the safety shift pin roll are installed in the gear box and the end cap of gear box. The gear pin roll and safety shift pin roll are in parallel with the output shaft. The upper end of the gear knockout plate runs through the gear pin roll and the safety shift pin roll respectively while the lower end of the gear knockout plate is inserted in the middle where the final-stage rack wheel and final-stage pinion are connected. The gear synchronous spring is set on the gear pin roll and at one side of the gear box. The safety shift spring is set in the safety shift pin roll and at one side of the end cap of gear box

Secondly, the gear knockout plate is in S-shaped structure.

Thirdly, the safety push rod is in hollow structure and set outside the safety shift pin roll. Stop pin is installed on the safety push rod so as to limit the safety shift spring.

Fourthly, the toothed end of the variable-speed pinion is installed on the end cap of gear box while the other end is installed on the gear box. The variable-speed rack wheel is installed in the middle of the variable-speed pinions with interference while the variable-speed pinion and variable-speed rack wheel mesh with the final-stage rack wheel and final-stage pinion respectively.

Fifthly, the big bevel pinion is installed on one side where the variable-speed pinion is closed to the gear box while the bevel pinion is installed on the motor and meshes with the big bevel pinion.

Sixthly, the grinding wheel shield is installed on the extended end of end cap of gear box, the surface of the grinding wheel shield contacts with the safety push rod and makes the safety push rod compress the safety shift spring.

When using this new practical tool, the variable-speed pinion will rotate synchronously after being driven by the big bevel pinion driven by motor through bevel pinion. When there is no sand grinding shield, the safety push rod and the safety shift spring are under free status and no pressure will be made to the gear knockout plate. Therefore, the gear knockout plate will suffer the pressure from the synchronous spring only and with such efforts, it will push the final-stage rack wheel to slide to the pinion on the variable-speed pinion axis to mesh with it. The variable-speed pinion will drive the output shaft to rotate through the final-stage rack wheel so as to shift in low speed.

When the machine operates under high-speed rotation speed of the angle grinding wheel polishing, it must be set with grinding wheel shield, the end of which will push the safety push rod, compress safety shift spring and act on the gear knockout plate to make the final-stage rack wheel and final-stage pinion separate from meshing. As the elasticity of the safety shift spring is greater than that of the gear synchronous spring and the final-stage rack wheel and final-stage pinion are set integrally, the final-stage pinion finally meshes with the variable-speed rack wheel and the machine will be under the high-speed working status.

Therefore, the safety push rod will bear no load if removing the sand grinding shield. The final-stage rack wheel will again mesh with the variable-speed pinion and the machine will recover to low-speed status to ensure that other working heads are under low-speed safe status when they are occupied.

The benefits of this new practical tool: the machine will not be under high-speed status automatically until the sand grinding shield is installed. The grinding wheel matched with it can be used only. The sand grinding shield needs removing when it is used for other working heads. At this time, the machine will recover to low-speed status automatically and disoperation can be avoided, being safe and convenient.

### BRIEF DESCRIPTION OF THE DRAWINGS

FIG. 1 Structure diagram

FIG. 2 Profile chart of gear structure

FIG. 3 Internal view of gear box

FIG. 4 Schematic diagram of low-speed action

FIG. 5 Schematic diagram of high-speed action

### DETAIL DESCRIPTION OF THE INVENTION

This new practical tool is further described below by combining the figures and specific implementation way.

Case 1

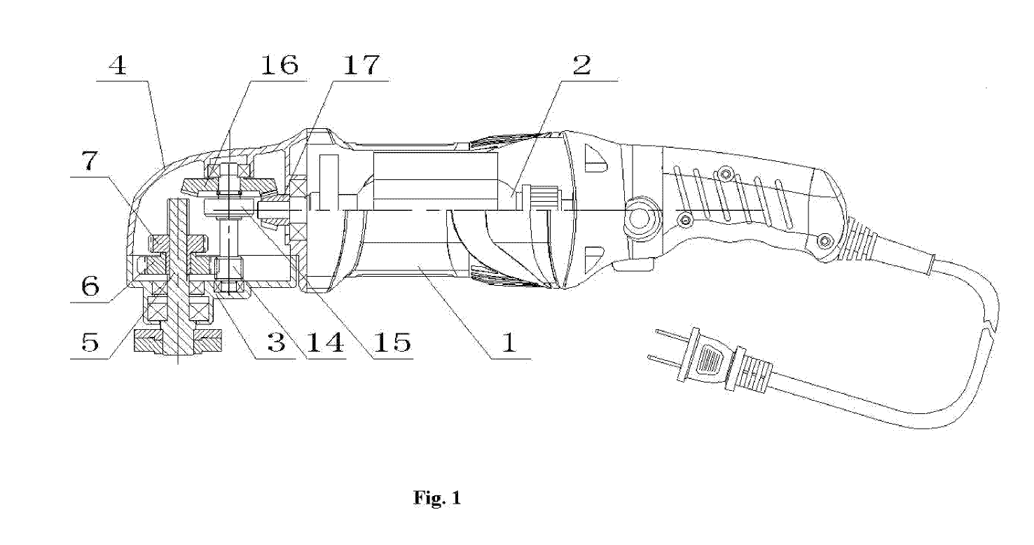

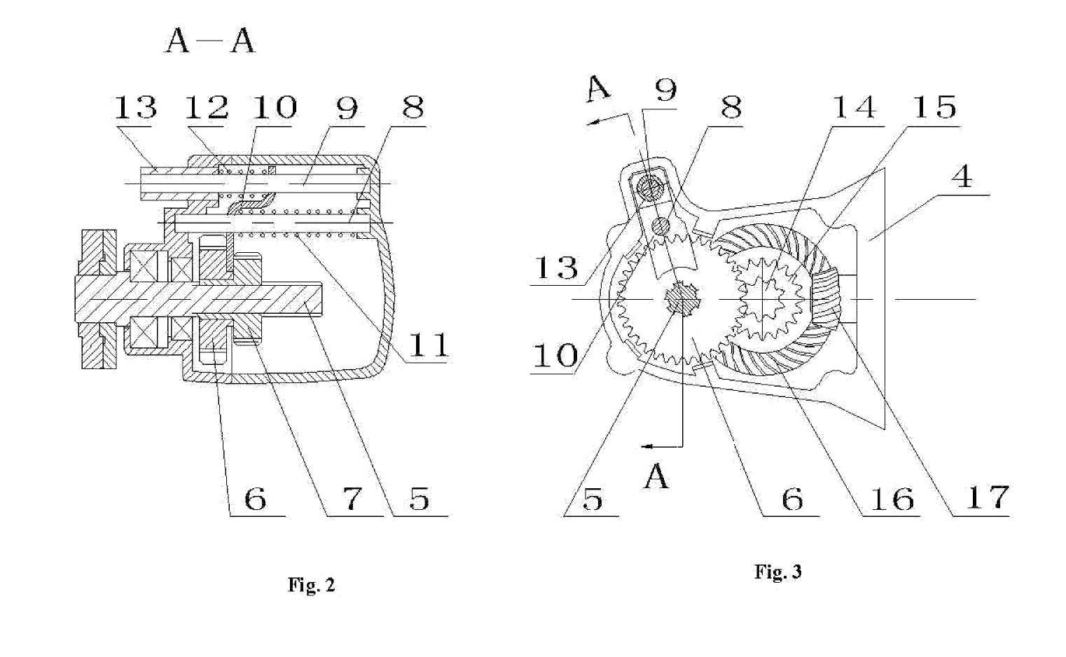

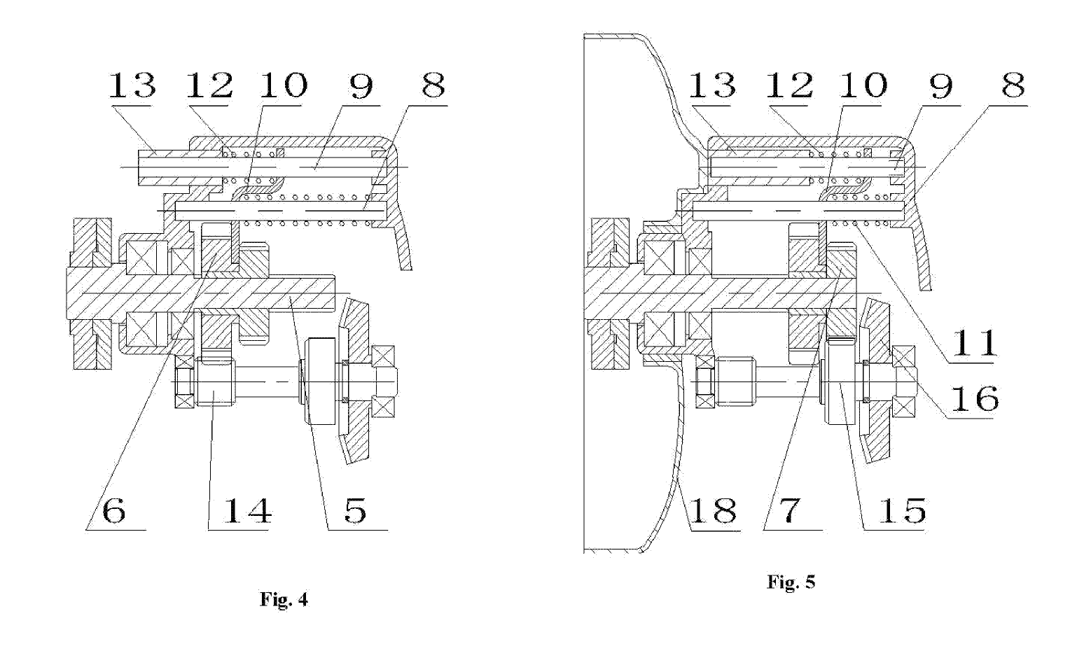

By referring to FIG. 1-5, it is one kind of hand-held electric power tool with safety shift device, including housing assembly 1, motor 2, end cap of gear box 3, gear box 4, output shaft 5, final-stage rack wheel 6, final-stage pinion 7, gear pin roll 8, safety shift pin roll 9, gear knockout plate 10, gear synchronous spring 11, safety shift spring 12, safety push rod 13, variable-speed pinion axis 14, variable-speed rack wheel 15, big bevel pinion 16, bevel pinion 17 and grinding wheel shield 18. Among which, the motor 2 is installed within the housing assembly 1, which is connected with the gear box 4; the end cap of the gear box 3 is connected with the other end of the gear box 4. The output shaft 5 is installed within the gear box 4 but comes out from the end cap of the gear box 3. The final-stage rack wheel 6 is installed on the final-stage pinion 7 in form of front and back axial direction. The final-stage rack wheel 6 and final-stage pinion 7 are installed on the output shaft 5 in form of spline; both ends of the gear pin roll 8 are installed in the gear box 4 and the end cap of gear box 3 respectively; both ends of the safety shift pin roll 9 are installed in the gear box 4 and the end cap of gear box 3. The gear pin roll 8 and safety shift pin roll 9 are in parallel with the output shaft 5. The upper end of the gear knockout plate 10 runs through the gear pin roll 8 and the safety shift pin roll 9 respectively while the lower end of the gear knockout plate 10 is inserted in the middle where the final-stage rack wheel 6 and final-stage pinion 7 are connected. The gear synchronous spring 11 is set on the gear pin roll 8 and at one side of the gear box 4. The safety shift spring 12 is set in the safety shift pin roll 9 and at one side of the end cap of gear box 3.

Secondly, the gear knockout plate 10 is in S-shaped structure.

Thirdly, the safety push rod 13 is in hollow structure and set outside the safety shift pin roll 9. One end of the safety push rod 13 comes out of end cap of gear box 3.

Fourthly, the toothed end of the variable-speed pinion 14 is installed on the end cap of gear box 3 while the other end is installed on the gear box 4. The variable-speed rack wheel 15 is installed in the middle of the variable-speed pinions 14 with interference while the variable-speed pinion 14 and variable-speed rack wheel 15 mesh with the final-stage rack wheel 6 and final-stage pinion 7 respectively.

Fifthly, the big bevel pinion 16 is installed on one side where the variable-speed pinion 14 is closed to the gear box 4 while the bevel pinion 17 is installed on the motor 2 and meshes with the big bevel pinion 16.

Sixthly, the grinding wheel shield 18 is installed on the extended end of end cap of gear box 3, the surface of the grinding wheel shield 18 contacts with the safety push rod 13 and makes the safety push rod 13 compress the safety shift spring 12.

When using this new practical tool, the big bevel pinion 16 is driven by motor 2 through bevel pinion 17. As the big bevel pinion 16 is installed with variable-speed pinion 14 with the same axis, the big bevel pinion 16 will drive variable-speed pinion axis 14 to rotate synchronously. Where there is no sand grinding shield 18, both the safety push rod 13 and safety shift spring 12 are under natural status. No pressure from safety push rod 13 and safety shift spring 12 will be made on the gear knockout plate 10, which will suffer the pressure from gear synchronous spring 11. Under the efforts of the gear synchronous spring 11, the gear knockout plate 10 pushes the final-stage rack wheel 6 to slide to gear of the variable-speed pinion axis and mesh with it. When the end surface of the teeth to be meshed on the final-stage rack wheel 6 and variable-speed pinion axis 14 coincides and is mutually locked, the final-stage rack wheel 6 will be unable to produce synchronous displacement and meshing is thus impossible. At this time, the gear knockout plate 10 will be unable to displace so as to make the gear synchronous spring 11 under the compression status and the thrust generated will be always on the gear knockout plate 10. The rotation of motor will drive the variable-speed pinion axis 14 to rotate and one pair of teeth to be meshed on the variable-speed pinion axis 14 and final-stage rack wheel 6 stagger mutually after displacing to their end surface, the gear knockout plate 10 will displace under the efforts of the gear synchronous spring 11, pushing the final-stage rack wheel 6 to displace and mesh with the variable-speed pinion 14 totally. Then, the final-stage rack wheel 6 will bring the output shaft to rotate and shift to make the machine operate in low speed.

When the machine needs to operate in high speed to bring the grinding wheel for grinding, the machine must be set with sand grinding shield 18, the end surface of which will push the safety push rod 13 to move towards gear box 4 and make safety shift spring 12 compress and act on shift knockout plate 10 so as to make the final-stage rack wheel 6 separate meshing from the variable-speed pinion axis 14. As the elasticity of safety shift spring 12 is greater than that of the gear synchronous spring 11 and the final-stage rack wheel is set with final-stage pinion totally, the shift knockout plate 10 will keep pushing the final-stage pinion 7 to mesh with the variable-speed rack wheel 15 on the variable-speed pinion axis 14. At this time, the machine will shift to high-speed working status.

Therefore, the safety push rod 13 will bear no force any more, the safety shift spring 12 will recover to natural status and the acting force will be cancelled if removing the sand grinding shield 18. With the thrust of the gear synchronous spring 11, the final-stage rack wheel 11 will again mesh with the variable-speed pinion axis 14 and the machine will recover to low-speed status to ensure the use safety.

1. A hand-held electric power tool with safety shift device comprising: housing assembly, motor, end cap of gear box, gear box, output shaft, final-stage rack wheel, final-stage pinion, gear pin roll, safety shift pin roll, gear knockout plate, gear synchronous spring, safety shift spring, safety push rod, stop pin, variable-speed pinion axis, variable-speed rack wheel, big bevel pinion, bevel pinion and grinding wheel shield; among which, the motor is installed within the housing assembly, which is connected with the gear box; the end cap of the gear box is connected with the other end of the gear box; the output shaft is installed within the gear box but comes out from the end cap of the gear box; the final-stage rack wheel is installed on the final-stage pinion in form of front and back axial direction. The final-stage rack wheel and final-stage pinion are installed on the output shaft in form of spline with the following features: both ends of the gear pin roll are installed in the gear box and the end cap of gear box respectively; both ends of the safety shift pin roll are installed in the gear box and the end cap of gear box; the gear pin roll and safety shift pin roll are in parallel with the output shaft, the upper end of the gear knockout plate runs through the gear pin roll and the safety shift pin roll respectively while the lower end of the gear knockout plate is inserted in the middle where the final-stage rack wheel and final-stage pinion are connected; the gear synchronous spring is set on the gear pin roll and at one side of the gear box; the safety shift spring is set in the safety shift pin roll and at one side of the end cap of gear box.

2. The hand-held electric power tool with safety shift device, as mentioned in claim 1, is characterized by the gear knockout plate in S-shaped structure.

3. The hand-held electric power tool with safety shift device, as mentioned in claim 2, has the following characteristics: the safety push rod is in hollow structure and is installed outside the safety shift pin roll. Stop pin is set on the safety push rod and will be used to limit the safety shift spring.

4. The hand-held electric power tool with safety shift device, as mentioned in claim 3, has the following characteristics: the toothed end of the variable-speed pinion is installed on the end cap of gear box while the other end is installed on the gear box. The variable-speed rack wheel is installed in the middle of the variable-speed pinions with interference while the variable-speed pinion and variable-speed rack wheel mesh with the final-stage rack wheel and final-stage pinion respectively.

5. The hand-held electric power tool with safety shift device, as mentioned in claim 4, has the following characteristics: the big bevel pinion is installed on one side where the variable-speed pinion is closed to the gear box while the bevel pinion is installed on the motor and meshes with the big bevel pinion.

6. The hand-held electric power tool with safety shift device, as mentioned in claim 1, has the following characteristics: the grinding wheel shield is installed on the extended end of end cap of gear box, the surface of the grinding wheel shield contacts with the safety push rod and makes the safety push rod compress the safety shift spring.

7. The hand-held electric power tool with safety shift device, as mentioned in claim 2, has the following characteristics: the grinding wheel shield is installed on the extended end of end cap of gear box, the surface of the grinding wheel shield contacts with the safety push rod and makes the safety push rod compress the safety shift spring.

8. The hand-held electric power tool with safety shift device, as mentioned in claim 3, has the following characteristics: the grinding wheel shield is installed on the extended end of end cap of gear box, the surface of the grinding wheel shield contacts with the safety push rod and makes the safety push rod compress the safety shift spring.

9. The hand-held electric power tool with safety shift device, as mentioned in claim 4, has the following characteristics: the grinding wheel shield is installed on the extended end of end cap of gear box, the surface of the grinding wheel shield contacts with the safety push rod and makes the safety push rod compress the safety shift spring.

10. The hand-held electric power tool with safety shift device, as mentioned in claim 5, has the following characteristics: the grinding wheel shield is installed on the extended end of end cap of gear box, the surface of the grinding wheel shield contacts with the safety push rod and makes the safety push rod compress the safety shift spring.
